(19) United States
(12) Patent Application Publication
(10) Pub. No.: US 2008/0040960 A1
(43) Pub. Date: Feb. 21, 2008

(54) Mobile Display

(76) Inventor: Jordan Keith, Dublin (IE)

Correspondence Address: JACOBSON HOLMAN PLLC, 400 SEVENTH STREET N.W., SUITE 600, WASHINGTON, DC, 20004, US

(21) Appl. No.: 11/665,738

(22) PCT Filed: Oct. 26, 2005
(86) PCT No.: PCT/IE05/00119

§ 371 Date: Apr. 20, 2007

Related U.S. Application Data
(60) Provisional application No. 60/621,654, filed on Oct. 26, 2004.

(51) Int. Cl. G09F 21/02

(52) U.S. Cl. 40/586

(57) ABSTRACT

A mobile display (1) comprises an electronic display element (2), a power source (4), and an apparatus (3) suitable for being worn by a person to support the display element (2) and the power source (4). A wearable computer for controlling operation of the display element (2) is housed within the apparatus (3). The apparatus (3) comprises a front part (13) configured to be located at the front of the wearer, and a rear part (14) configured to be located at the rear of the wearer. The front part (13) and the rear part (14) are formed integrally from a fibre reinforced composite material. The display element (2) is attached to the front part (13) at a hinge region (5). This hinged attachment facilitates hinging movement of the display element (2) relative to the front part (13) between a display configuration and an interface configuration. The display element (2) has a front side (6) for displaying and a rear side (7). User interface means are supported on the rear side (7) of the display element (2). The power source (4) is detachably coupled to the lower end of the rear part (14) by abutting an end of the power source (4) with an end of the rear part (14). In this manner, the power source (4) forms a continuous, smooth, planar extension of the rear part (14).

### INTRODUCTION

This invention relates to a mobile display. In particular this invention relates to a mobile display suitable for use in advertising activities.

Advertising is a huge industry in which large amounts of money are often spent on various advertising media to convey a desired message. However even the most expensive and sophisticated advertising campaigns generally rely on display of information in a “broad brush” manner.

This invention is aimed at providing a mobile display which enables more targeted and meaningful advertising to be achieved.

### STATEMENTS OF INVENTION

According to the invention there is provided a mobile display comprising:
an electronic display element; and
an apparatus suitable for being worn by a person to support the display element;
the display element being movable relative to the apparatus between a display configuration and an interface configuration.

Because the apparatus is worn by the person, this ensures that the display element has a high degree of mobility. By using the display element to conduct an advertising campaign, the mobile display of the invention enables highly focused advertising to be achieved.

In one embodiment of the invention the display element is hingeable relative to the apparatus between the display configuration and the interface configuration. Preferably the display element is attached to the apparatus at a hinge region.

The display may comprise a user interface for information input/output between a user and the display element. Preferably the user interface is accessible in the interface configuration. Ideally the user interface is inaccessible in the display configuration. The user interface may be supported by the display element. The display element may have a front side for displaying and a rear side, and the user interface may be supported by the rear side of the display element. Most preferably the user interface comprises a printing device, and/or a scanning device, and/or an audio recording device, and/or an audio transmitting device, and/or a touch screen interface, and/or a magnetic swipe device, and/or a keypad, and/or a camera.

The user interface may be configured to be located substantially below the head of a wearer.

In another case in the display configuration, the display element is configured to be located substantially parallel to a wearer. Preferably in the display configuration, the front side of the display element is configured to face substantially away from a wearer.

In another case in the interface configuration, the display element is configured to be located substantially perpendicular to a wearer. Preferably in the interface configuration, the rear side of the display element is configured to face substantially towards the head of a wearer. In the interface configuration, the rear side of the display element may be configured to face substantially upwards.

The apparatus preferably comprises a front part configured to be located at the front of a wearer. The apparatus may comprise a rear part configured to be located at the rear of a wearer. The front and rear parts assist in distributing the weight of the display element for greater comfort of the wearer. In particular the weight of the parts and/or the display element will not tend to cause the wearer to lose balance and fall forwards or backwards. By arranging the apparatus close around the torso of the wearer, this enhances the stability and comfort of the apparatus. In particular the possibility of the wearer losing balance or being knocked over, for example due to a gust of wind is minimised. This aspect of the invention is further improved due to the fact that the parts are in some cases below the wearer's head. Ideally the front part is formed integrally with the rear part. Most preferably the front part is substantially planar. The front part may be configured to extend substantially across the chest of a wearer. The rear part may be substantially planar. The rear part may be configured to extend substantially across the back of a wearer. In a preferred case the apparatus comprises at least one bearing member configured to extend over a shoulder of a wearer between the front part and the rear part. The bearing member bears against the shoulder of the wearer to transfer the load of the display element to the wearer. Ideally the at least one bearing member is formed integrally with the front part and with the rear part.

The apparatus may be of a polymeric material. Preferably the apparatus is of a reinforced composite material. Ideally the material comprises ABS.

In one embodiment the front part is substantially fixed relative to the rear part. Preferably the apparatus is substantially rigid.

The display element may be supported by the front part.

In the display configuration, the display element is preferably substantially parallel to the front part. In the interface configuration, the display element is preferably substantially perpendicular to the front part.

The display element may be substantially planar.

The display may comprise a power source. Preferably the power source is detachably coupled to the apparatus. Conveniently the power source may be detached from the apparatus for repair and/or replacement and/or recharging. The power source may be substantially planar. When coupled to the apparatus, the power source may form a planar extension of the apparatus. Ideally the power source is detachably coupled to the rear part. The power source may be detachably coupled to a lower end of the rear part. The power source may comprise a battery, or a fuel cell or the like. The power source may comprise a housing for supporting a battery, or fuel cell, or the like. The housing may be of a polymeric material, or of a reinforced composite material, such as ABS.

In a further embodiment the display comprises a wearable computer for controlling the display element. Preferably the wearable computer is configured to facilitate wireless communication between the wearable computer and a communications device remote from the wearable computer. The wireless communication between the wearable computer and the remote communications device enables the advertising campaign being conducted by the wearable computer to be rapidly updated, for example in response to feedback received. Ideally the wearable computer is supported by the apparatus. Most preferably the wearable computer is housed within the apparatus.

The display element preferably comprises a screen for displaying a visual image. Ideally the screen is daylight-viewable. The daylight-viewable screen enables the display element to be used day and night. The screen brightness output may be at least 1000 nits. Preferably the screen brightness output is approximately 1500 nits.

The width of the display unit is preferably at least 20 cm, ideally at least 25 cm, and most preferably approximately 30 cm.

The height of the display element is preferably at least 15 cm, and ideally approximately 20 cm.

The display may comprise a source of visual images, such as a DVD player. The display element may be configured to be located substantially below the head of a wearer.

According to another aspect, the invention provides an apparatus suitable for being worn by a person to support a mobile electronic display system, the apparatus comprising:
a front part configured to be located at the front of a wearer, and a rear part configured to be located at the rear of a wearer;
the front part being formed integrally with the rear part.

The front part may be substantially planar. The front part may be configured to extend substantially across the chest of a wearer.

The rear part may be substantially planar. The rear part may be configured to extend substantially across the back of a wearer.

The apparatus may comprise at least one bearing member configured to extend over a shoulder of a wearer between the front part and the rear part. The at least one bearing member may be formed integrally with the front part and with the rear part.

The apparatus may be of a polymeric material. The apparatus may be of a reinforced composite material. The material may comprise ABS.

The front part may be substantially fixed relative to the rear part. The apparatus may be substantially rigid.

In a further aspect the invention provides a mobile display comprising:
an electronic display element;
an apparatus suitable for being worn by a person to support the display element; and
a power source coupled to the apparatus to form a planar extension of the apparatus.

The power source may be detachably coupled to the apparatus. The power source may be substantially planar. The apparatus may comprise a front part configured to be located at the front of a wearer and a rear part configured to be located at the rear of a wearer. The power source may be coupled to the rear part. The power source may be coupled to a lower end of the rear part. The rear part may be substantially planar.

### BRIEF DESCRIPTION OF THE DRAWINGS

The invention will be more clearly understood from the following description of an embodiment thereof, given by way of example only, with reference to the accompanying drawings, in which:

FIG. 1 is a perspective view from the front of a mobile display according to the invention;

FIG. 2 is a perspective view from the rear of the mobile display of FIG. 1;

FIG. 3 is a perspective view from the front of the mobile display of FIG. 1 in a display configuration;

FIG. 4 is a perspective view from the front of the mobile display of FIG. 1 in an interface configuration;

FIG. 5 is a perspective view from the rear of the mobile display of FIG. 1 with a power source part attached;

FIG. 6 is a perspective view from the rear of the mobile display of FIG. 1 with the power source part detached;

FIG. 7 is a block diagram illustrating the architecture of the technology core, the connectivity points, the network protocols and the peripheral connectivity;

FIG. 8 is a perspective view from the front of a person wearing the mobile display of FIG. 1 in the display configuration; and

FIGS. 9 and 10 are perspective views from the front of a person wearing the mobile display of FIG. 1 in the interface configuration.

### DETAILED DESCRIPTION

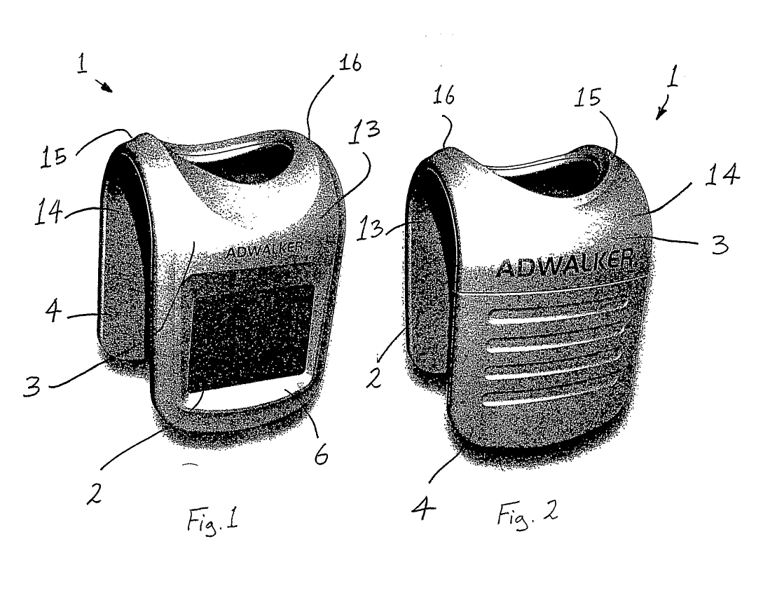

Referring to the drawings, and initially to FIGS. 1 to 6 thereof, there is illustrated a mobile display 1 according to the invention. The mobile display 1 comprises a planar electronic display element 2, a planar power source 4, and an apparatus 3 suitable for being worn by a person to support the display element 2 and the power source 4. A wearable computer is housed within the apparatus 3, the wearable computer being suitable for controlling operation of the display element 2.

The apparatus 3 is relatively rigid and is suitable for being worn by a person. The apparatus 3 comprises a front part 13 configured to be located at the front of the wearer, a rear part 14 configured to be located at the rear of the wearer, a first bearing member 15 configured to extend over a first shoulder of the wearer, and a second bearing member 16 configured to extend over a second shoulder of the wearer. The front part 13 is substantially planar and extends substantially across the chest of the wearer. Similarly the rear part 14 is substantially planar and extends substantially across the back of the wearer. Each bearing member 15, 16 extends from the front part 13 to the rear part 14 in a semi-circular shape. Both the front part 13 and the rear part 14 are located beneath the wearer's head. Overall, the apparatus 3 is substantially “U”-shaped in side-view.

The front part 13, the rear part 14 and the two bearing members 15, 16 are all formed integrally from a fibre reinforced composite material. A suitable material for forming the integral apparatus 3 is a plastic composite, for example ABS.

In this manner, the front part 13 and the rear part 14 are supported by the bearing members 15, 16.

The rigid nature of the integral apparatus 3 maintains the position of the front part 13 fixed relative to the position of the rear part 14. This results in a more stable and comfortable to wear arrangement. The apparatus 3 thus assists in better weight distribution and a more ergonomically suited arrangement. The apparatus 3 was especially designed to achieve this technical effect following extensive anthropometric assessment.

A camera 17 and two audio speakers 18 are provided at the top of the front part 13.

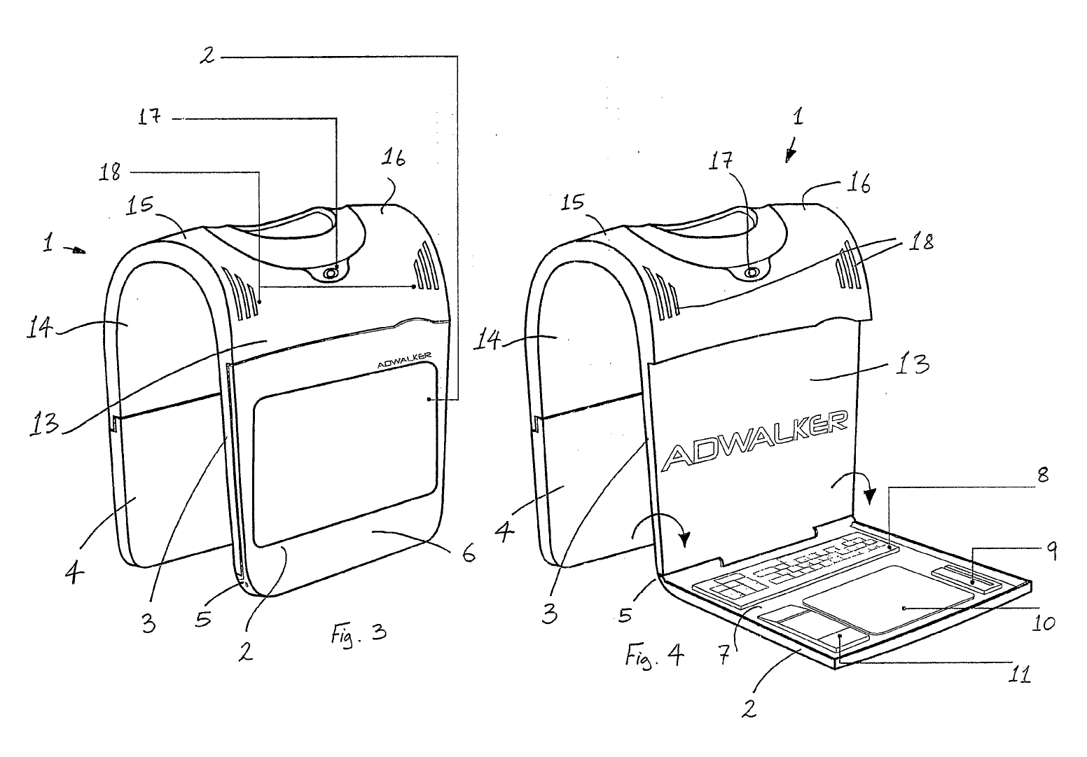

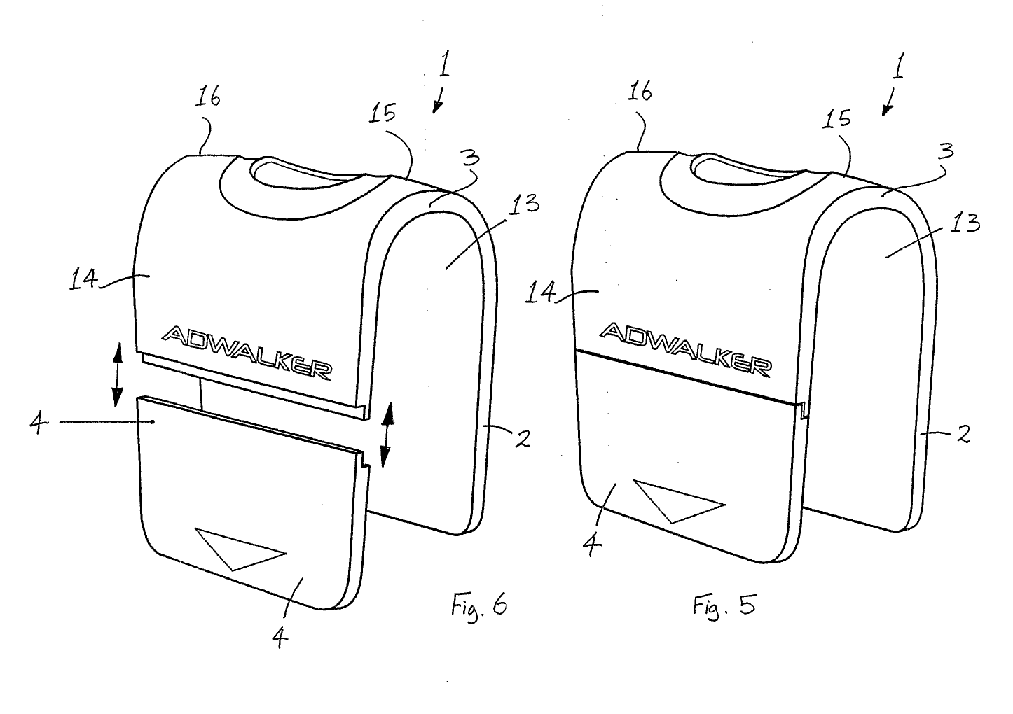

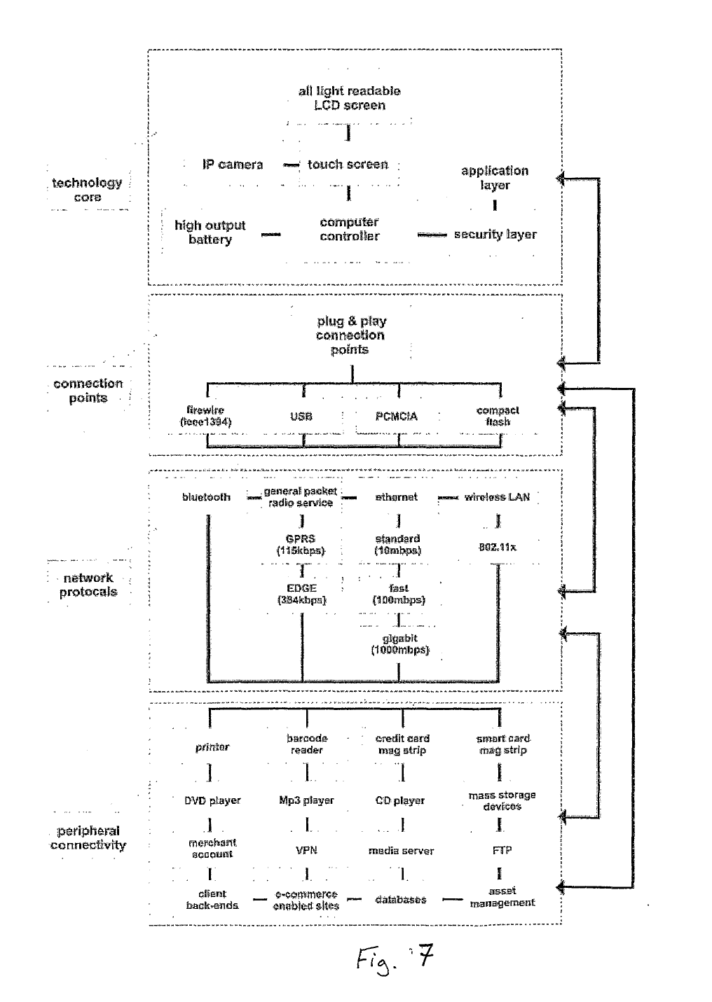

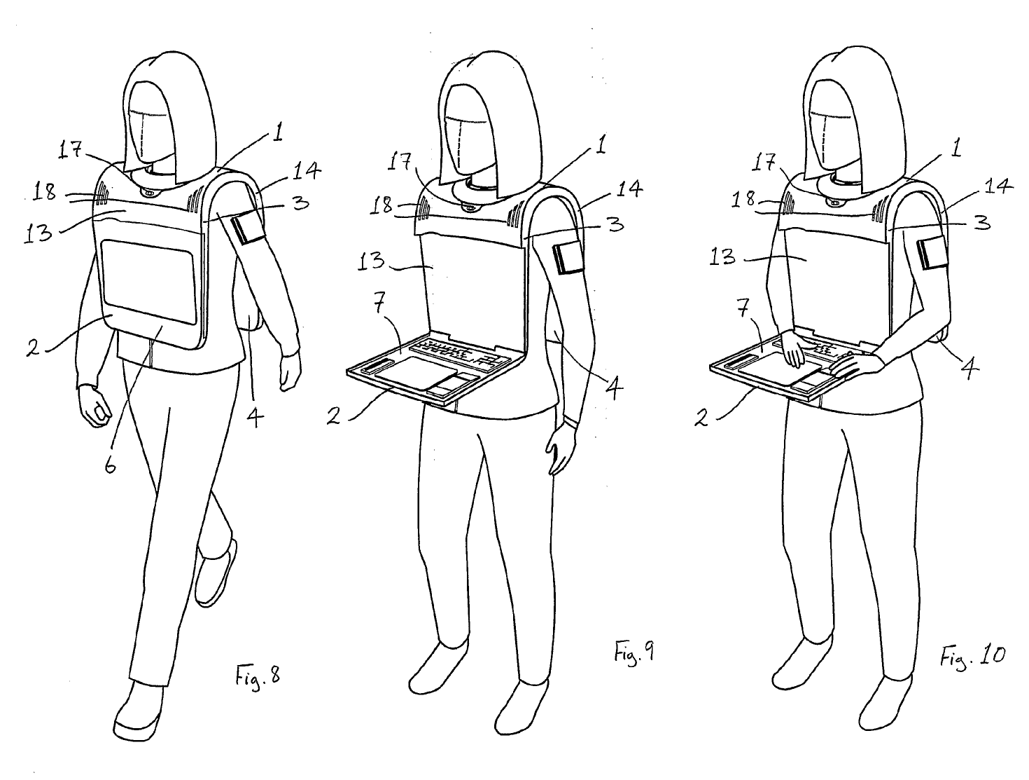

The display element 2 is attached to the front part 13 at a hinge region 5. This hinged attachment facilitates hinging movement of the display element 2 relative to the front part 13 between a display configuration (FIG. 3) and an interface configuration (FIG. 4).

The display element 2 has a front side 6 for displaying and a rear side 7. User interface means are supported on the rear side 7 of the display element 2. The user interface means facilitate information input/output between a user and the display element 2. In this case, the user interface means comprises a keypad 8, a magnetic swipe 9, a data capture screen 10 and a printer 11. Alternative user interface means include a scanning device, an audio recording device, an audio transmitting device, a touch-screen interface, a camera.

When the mobile display 1 is worn by a person, the display element 2 and the user interface means are located below the wearer's head.

In the display configuration, the display element 2 is substantially parallel to the front part 13 and substantially parallel to the chest/front torso region of the wearer, with the front side 6 of the display element 2 facing substantially away from the wearer. This arrangement maximises the visibility of the display element 2 to people that the wearer passes by, or that pass the wearer by. The rear side 7 engages against the planar front part 13 in the display configuration, and thus the user interface is inaccessible in the display configuration.

In the interface configuration, the display element 2 is substantially perpendicular to the front part 13 and substantially perpendicular to the chest/front torso region of the wearer, with the rear side 7 of the display element 2 facing upwards, substantially towards the head of the wearer. The user interface is therefore accessible in the interface configuration.

Information input/output between the user and the display element 2 and/or the wearable computer may be achieved using a variety of user interface means. For example the printer 11 may be employed to print tickets or coupons, the magnetic swipe 9 may be employed to scan a credit card to effect payment for a service being advertised by the display element 2.

In this case, the display element 2 comprises a daylight-viewable, electronic flat-panel screen for displaying a visual image. Operation of the screen is controlled by the wearable computer. The screen preferably has a brightness output of at least 1000 nits, and in this case preferably 1500 nits.

The screen preferably has a width of at least 20 cm, most preferably at least 25 cm, and ideally 30 cm. The screen preferably has a height of at least 15 cm, and ideally 20 cm. In this manner, the screen is more easily visible to people that the wearer of the apparatus 3 passes by, to maximise communication between the screen and the people passed by the wearer.

The power source 4 is detachably coupled to the rear part 14. As illustrated in FIGS. 5 and 6, the power source 4 may be attached to a lower end of the rear part 14 by abutting an end of the power source 4 with an end of the rear part 14. In this manner, the power source 4 forms a continuous, smooth, planar extension of the rear part 14. Suitable attachment means may be employed for attaching the power source 4 to the rear part 14, such as a snap-fit arrangement, or magnetic fasteners, or clips.

The power source 4 may be quickly and easily detached from the rear part 14, for example to replace and/or repair and/or recharge the power source 4.

The power source 4 is provided, in this case, in the form of a high-output battery.

It will be appreciated that the power source 4 may comprise a housing into which a battery or fuel cell may be received. The housing could then be attached to the apparatus 3.

Alternatively the power source 4 may comprise an all-in-one battery or fuel cell.

The housing may be of a polymeric material, or of a reinforced composite material, such as ABS.

A variety of possible wearable computers may be employed. In this case, wireless communication is possible between the wearable computer and a communications device remote from the wearable computer. The apparatus 3 may support an antenna for wireless communication at the rear.

The wearable computer allows information input in various modes, including touch-screen technology on the screen, and handwriting recognition. Speakers can be incorporated in the chassis and used to output music or any desired sound. Also the apparatus can record video footage. Any data captured can be stored locally, and it can be communicated via wireless networks with other fixed or wireless computing devices. This allows it, for example, to convey information about its surroundings. The visual and/or sound content can be from DVD or video, or software for location-specific demonstrations. For example a location-specific download may relate to a retail premises where the mobile display 1 is located.

For both information and security, the mobile display 1 may be tracked, and it may be remotely updated with content or software. Information can be captured locally for polling/surveys, and it can transmit results dynamically.

The various functions of the display element 2 and the wearable computer are shown in more detail in FIG. 7. This architecture allows excellent versatility for both local and remote communication and for configuration of peripherals. As is clear from this block diagram, the wearable computer includes a controller, a security layer, an application layer, the screen, and the high-output battery. Various “plug-and-play” connection points allow a variety of devices to be connected for input or output or data or contact in a very versatile manner. A range of network protocols also allow excellent versatility for communication, both locally (for example, Bluetooth) and remotely (for example, GPRS). The peripheral connectivity items allow configuration of the wearable computer in a highly versatile manner, as shown in FIG. 7.

In more detail, the mobile display 1 may have an integrated IP camera built into the front (above the screen). This allows remote monitoring and interactive two-way video messaging through a wireless network. The camera may be connected through an Ethernet connection integrated into the pack. The camera may have a built-in web server and static IP address. Remote pan/tilt operations with web-based viewing are also available. The camera may be outdoor ready and splash resistant for wet weather operation. Images can be transmitted to virtually any Internet Device, including a handheld PC or even on the LCD of an Internet-ready cell phone. The wearable computer may also send these images anywhere in the world when the camera is triggered by a set timer. Clients can view real-time iterations of their campaigns regardless of their location.

The mobile display 1 also enables remote monitoring. The client has the ability to place a secure web address into a web browser and view in real time each individual mobile display 1 in operation regardless of their location. This enables the client to verify the mobile display 1 is operating in the required location, monitor the campaigns as they happen (real-time), make decisions regards copy iterations, e.g. if an offer displayed on the screen is not having the desired result they can order an update broadcast changing the price or text.

Another feature is the ability to integrate call centres into a deployment. The wearable computer uses two-way messaging to further enhance interaction. The user sees the client service representative in the call centre on the screen and the client service representative sees the user on the street. Using an external microphone the user can talk in real time to the representative and request more information on specific offers.

The mobile display 1 may be operated in a wide range of uses, such as the following:

Brand/Product Advertising

The mobile display 1 can distribute broadcast quality messaging. Advertisers can deliver messaging applicable to new product launches, established brands/products, compliment existing ‘traditional’ media activity and deliver a purchase ‘call to action’ in the most relevant locations with precise timing. Bespoke advertising and marketing messages may be relayed to the target consumer depending on location, varying target audience, time of the day and seasonality.

Ticketing & on-Demand Customised Printing

The mobile display 1 can provide secure mobile/remote ticketing at street level. A direct thermal printer 11 has rubberised over-moulding to maintain both rugged construction and minimal weight. It supports fonts from 12 to 48 pt and can include optional character sets. Secure bar-code symbologies include Code 39, Code 128, Interleaved 2 of 5, Postnet, UPC-A and UCC/EAN 128. It can create customised customer loyalty cards and secure gift cards on demand or serve customers faster with mobile transaction systems for point-of-sale and returns processing.

Gaming and Competitions

Interactive customised games and competitions may be played, such as “giveaways” and opt-in marketing based competitions. The mobile display 1 has the ability to interact with consumers on multiple levels and provides enhanced entertainment.

Data Capture

Data can be captured and downloaded to a client database. Consumer data can be entered directly by the wearer or by the consumer, and distributed in real-time to clients.

Research

Research can be conducted ‘in the field’ and monitored in real time through wireless broadcast facilities.

Promotions

A range of promotions can be activated using the mobile display 1. Promotions can be enhanced in conjunction with a traditional media brand campaign or in isolation. The platform can lead to promotional copy being iterated in real time depending on consumer response.

Information Services

Real time information and location specific services (GPS), such as sport and business updates and localised dynamic tourist information can be delivered via a dedicated digital network.

Monitoring/Evaluation

Through the apparatus dedicated digital network, advertisers and marketers can monitor the performance of their campaigns.

Smart Cards/Credit cards

Smart Card and Credit Card capabilities can be integrated into the platform in order to facilitate secure financial transactions.

It will be appreciated that the mobile display 1 may be employed in a variety of possible applications, for example:
Brand and product advertising
Promotions
Interactive messaging (SMS, MMS, Bluetooth)
Research and data mining
Interactive games and competitions
Ticketing
Digital coupons
Financial transactions
Reservations
Interactive demonstrations
Location specific information services
Commercial messaging and advertising
Sales promotion
Public relations
Direct marketing
Direct sales

The invention is not limited to the embodiment hereinbefore described, with reference to the accompanying drawings, which may be varied in construction and detail.

1-74. (canceled)

75: A mobile display comprising:
an electronic display element; and
an apparatus suitable for being worn by a person to support the display element;
the display element being movable relative to the apparatus between a display configuration and an interface configuration.

76: The display as claimed in claim 75 wherein the display element is hingeable relative to the apparatus between the display configuration and the interface configuration.

77: The display as claimed in claim 75 wherein the display comprises a user interface for information input/output between a user and the display element.

78: The display as claimed in claim 75 wherein in the display configuration, the display element is configured to be located substantially parallel to a wearer.

79: The display as claimed in claim 75 wherein in the interface configuration, the display element is configured to be located substantially perpendicular to a wearer.

80: The display as claimed in claim 75 wherein the apparatus comprises a front part configured to be located at the front of a wearer.

81: The display as claimed in claim 75 wherein the apparatus comprises a rear part configured to be located at the rear of a wearer.

82: The display as claimed in claim 80 wherein the front part is substantially planar.

83: The display as claimed in claim 80 wherein the front part is configured to extend substantially across the chest of a wearer.

84: The display as claimed in claim 81 wherein the rear part is substantially planar.

85: The display as claimed in claim 81 wherein the rear part is configured to extend substantially across the back of a wearer.

86: The display as claimed in claim 80 wherein the apparatus comprises at least one bearing member configured to extend over a shoulder of a wearer between the front part and the rear part.

87: The display as claimed in claim 75 wherein the apparatus is of a polymeric material.

88: The display as claimed in claim 75 wherein the apparatus is of a reinforced composite material.

89: The display as claimed in claim 80 wherein the front part is substantially fixed relative to the rear part.

90: The display as claimed in claim 80 wherein the display element is supported by the front part.

91: The display as claimed in claim 80 wherein in the display configuration, the display element is substantially parallel to the front part.

92: The display as claimed in claim 80 wherein in the interface configuration, the display element is substantially perpendicular to the front part.

93: The display as claimed in claim 75 wherein the display element is substantially planar.

94: The display as claimed in claim 75 wherein the display comprises a power source.

95: The display as claimed in claim 75 wherein the display comprises a wearable computer for controlling the display element.

96: The display as claimed in claim 75 wherein the display element comprises a screen for displaying a visual image.

97: The display as claimed in claim 75 wherein the display element is configured to be located substantially below the head of wearer.

98: A apparatus suitable for being worn by a person to support a mobile electronic display system, the apparatus comprising:
a front part configured to be located at the front of a wearer, and a rear part configured to be located at the rear of a wearer;
the front part being formed integrally with the rear part.

99: The apparatus as claimed in claim 98 wherein the front part is substantially planar.

100: The apparatus as claimed in claim 98 wherein the front part is configured to extend substantially across the chest of a wearer.

101: The apparatus as claimed in claim 98 wherein the rear part is substantially planar.

102: The apparatus as claimed in claim 98 wherein the rear part is configured to extend substantially across the back of a wearer.

103: The apparatus as claimed in claim 98 wherein the apparatus comprises at least one bearing member configured to extend over a shoulder of a wearer between the front part and the rear part.

104: The apparatus as claimed in claim 98 wherein the apparatus is of a polymeric material.

105: The apparatus as claimed in claim 98 wherein the apparatus is of a reinforced composite material.

106: The apparatus as claimed in claim 98 wherein the front part is substantially fixed relative to the rear part.

107: A mobile display comprising:
an electronic display element;
an apparatus suitable for being worn by a person to support the display element; and
a power source coupled to the apparatus to form a planar extension of the apparatus.

108: The display as claimed in claim 107 wherein the power source is detachably coupled to the apparatus.

109: The display as claimed in claim 107 wherein the power source is substantially planar.

110: The display as claimed in claim 107 wherein the apparatus comprises a front part configured to be located at the front of a wearer and a rear part configured to be located at the rear of a wearer.
